(19) United States
(12) Patent Application Publication
(10) Pub. No.: US 2025/0174907 A1
(43) Pub. Date: May 29, 2025

(54) MULTIPLEXER AND ARRAY ANTENNA MODULE

(71) Applicant: Chiun Mai Communication Systems, Inc., New Taipei (TW)

(72) Inventors: LUNG-TA CHANG, New Taipei (TW); Chia-Hsien Chen, New Taipei (TW); Shao-Yi Tai, New Taipei (TW); Ping-Chi Kao, New Taipei (TW); Peng-Hao Huang, New Taipei (TW); Tsung-Bin Chang, New Taipei (TW)

(21) Appl. No.: 18/961,910

(22) Filed: Nov. 27, 2024

(30) Foreign Application Priority Data
Nov. 28, 2023 (CN) 202311626512.4

(51) Int. Cl. H01Q 21/00; H01Q 1/28

(52) U.S. Cl. CPC H01Q 21/0025; H01Q 1/288

(57) ABSTRACT

A multiplexer and an antenna array module applying the multiplexer are provided, the array antenna module includes an array antenna and a beamforming module, the multiplexer includes a first end and at least two second ends extending towards the first end. One of the first end or the at least two second ends is connected to the array antenna, the other one of the first end or the at least two second ends is connected to the beamforming module, the first end and the at least two second ends are configured to conduct signals between the array antenna and the beamforming module.

### CROSS-REFERENCE TO RELATED APPLICATIONS

This application claims priority to Chinese Patent Application No. 202311626512.4 filed on Nov. 28, 2023, in China National Intellectual Property Administration, the contents of which are incorporated by reference herein.

### FIELD

The subject matter herein generally relates to antenna technology field, and more particularly to a multiplexer and an array antenna module.

### BACKGROUND

Low-orbit satellite system (LEO) is a large satellite system composed of multiple satellites that can process real-time information. Low-orbit satellites are also used for communications in mobile terminals such as mobile phones. Due to the low orbit altitude, the mobile terminals using the low-orbit satellite communications have the advantages of short transmission delay and small path loss. A mobile communication system consisting of multiple low-orbit satellites can achieve true global coverage and more efficient frequency reuse. Cellular communication, multiple access, spot beam, frequency reuse and other technologies also provide technical support for the application of low-orbit satellites in mobile communications. In short, low-orbit satellites are currently highly regarded as mobile communication systems.

However, in order to reduce the overall area of the antenna design, the existing array antenna modules used in low-orbit satellites have a relatively close arrangement distance between transmitting antennas and receiving antennas, which makes signal transmission and wiring between antennas difficult, so that the design of the array antenna requires more considerations.

### BRIEF DESCRIPTION OF THE DRAWINGS

Implementations of the present disclosure will now be described, by way of embodiments, with reference to the attached figures.

FIG. 1 is a functional block diagram of an array antenna module according to an embodiment of the present application.

FIG. 2 is a structural diagram of a multiplexer of the array antenna module according to an embodiment of the present application.

FIG. 3 is a structural diagram of a multiplexer of the array antenna module according to another embodiment of the present application.

FIG. 4 is a cross-sectional diagram of the array antenna module according to an embodiment of the present application.

FIG. 5 is a structural diagram of the array antenna module according to an embodiment of the present application.

FIG. 6 is another structural diagram of the array antenna module according to an embodiment of the present application.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

Low-orbit satellite system (LEO) is a large satellite system composed of multiple satellites that can process real-time information. Low-orbit satellites are also used for communications in mobile terminals such as mobile phones. Due to the low orbit altitude, the mobile terminals using the low-orbit satellite communications have the advantages of short transmission delay and small path loss. A mobile communication system consisting of multiple low-orbit satellites can achieve true global coverage and more efficient frequency reuse. Cellular communication, multiple access, spot beam, frequency reuse and other technologies also provide technical support for the application of low-orbit satellites in mobile communications. In short, low-orbit satellites are currently highly regarded as mobile communication systems.

However, in order to reduce the overall area of the antenna design, the existing array antenna modules used in low-orbit satellites have a relatively close arrangement distance between transmitting antennas and receiving antennas, which makes signal transmission and wiring between antennas difficult, so that the design of the array antenna requires more considerations.

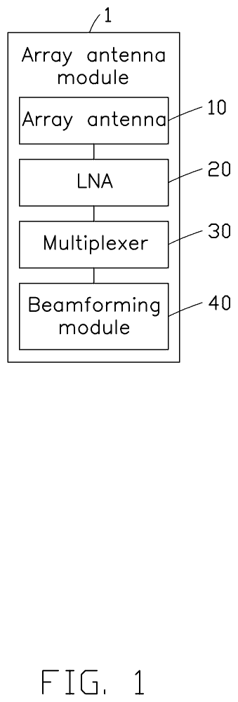

Referring to FIG. 1, FIG. 1 illustrates a functional block diagram of an array antenna module 1 according to an embodiment of the present application. The array antenna module 1 can be applied in a wireless communication device (not shown) for realizing wireless communication of the wireless communication device based on low-orbit satellites. The array antenna module 1 can be configured to transmit or receive wireless communication signals for realizing wireless communication.

Referring to FIG. 1, the array antenna module 1 includes an array antenna 10, a low noise amplifier (LNA) 20, a multiplexer 30, and a beamforming module 40.

The array antenna 10, the LNA 20, the multiplexer 30, and the beamforming module 40 are electrically connected in series. The array antenna 10 is configured to transmit or receive wireless communication signals. One end of the multiplexer 30 is connected to the array antenna 10 via the LNA 20, and another end of the multiplexer 30 is connected to the beamforming module 40. The LNA 20 can be used to obtain a wireless communication signal from the array antenna 10 and output the wireless communication signal to the multiplexer 30 after amplification, or obtain a wireless communication signal from the multiplexer 30 and output the wireless communication signal to the array antenna 10 after amplification. The multiplexer 30 may be used to transmit the wireless communication signal of the array antenna 10 to the beamforming module 40, or transmit the wireless communication signal of the beamforming module 40 to the beamforming module 40. The beamforming module 40 can be used to obtain the wireless communication signal from the array antenna 10 through the multiplexer 30 and analyze it, or compile the wireless communication signal and transmit it to the array antenna 10 through the multiplexer 30.

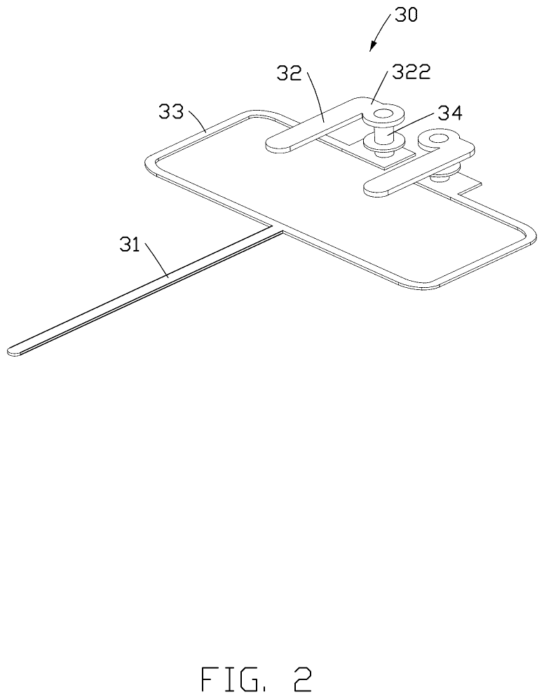

Referring to FIG. 2 together, the multiplexer 30 includes a first end 31, at least two second ends 32, a first connecting portion 33, and at least two second connecting portions 34.

One of the first end 31 and the at least two second ends 32 is connected to the array antenna 10, the other one of the first end 31 and the at least two second ends 32 is connected to the beamforming module 40. In some embodiments, the first end 31 and the at least two second ends 32 are both substantially linear metal segment structures and are substantially parallel to each other. The at least two second ends 32 are coplanar. The first end 31 and the at least two second ends 32 are non-coplanar.

The first connecting portion 33 is connected to the first end 31 and is coplanar with the first end 31. In some embodiments, the first connecting portion 33 is substantially a rectangular ring-shaped metal segment structure, and the first end 31 is connected to a substantially middle position of a long side of the rectangular ring-shaped first connecting portion 33. In some embodiments, the plane or layer where the first end 31 and the first connecting portion 33 are located is substantially parallel to a plane or layer where the at least two second ends 32 are located. In some embodiments, the first connecting portion 33 may also be in other symmetrical regular shapes, such as a circle, an ellipse, a rectangle, a straight line, or a combination of any two of the above shapes, and the first connecting portion 33 may be in a symmetrical structure with respect to the first end 31; or the first connecting portion 33 may also be in an asymmetrical or irregular shape. In contrast, when the first connecting portion 33 is in a symmetrical regular shape, the signal conduction effect is better because the signal conduction paths are substantially the same.

One end of each of the at least two second connecting portions 34 is connected to an end of the first connecting portion 33 away from the first end 31, and the other end of the at least two second connecting portions 34 are connected to the at least two second ends 32, respectively. The second connecting portions 34 connect the plane or layer where the first end 31 is located and the plane or layer where the at least two second ends 32 are located. In some embodiments, the second connecting portions 34 may be, but is not limited to, two metal columns, one end of the two metal columns is connected to the at least two second ends 32, and the other end of the two metal columns is connected to a substantially middle position of a long side of the rectangular ring-shaped first connecting portion 33 that away from the first end 31.

In some embodiments, each of the at least two second ends 32 includes a connection point 322, the connection point 322 is connected to the second connecting portion 34, the second end 32 is formed by the connection point 322 extending from the second connecting portion 34 toward the first end 31. In some embodiments, a projection of the at least two second ends 32 in a first direction are located within a projection range of the first connecting portion 33 in the first direction. The first direction is a direction in which the at least two second ends 32 are perpendicular to the first connecting portion 33.

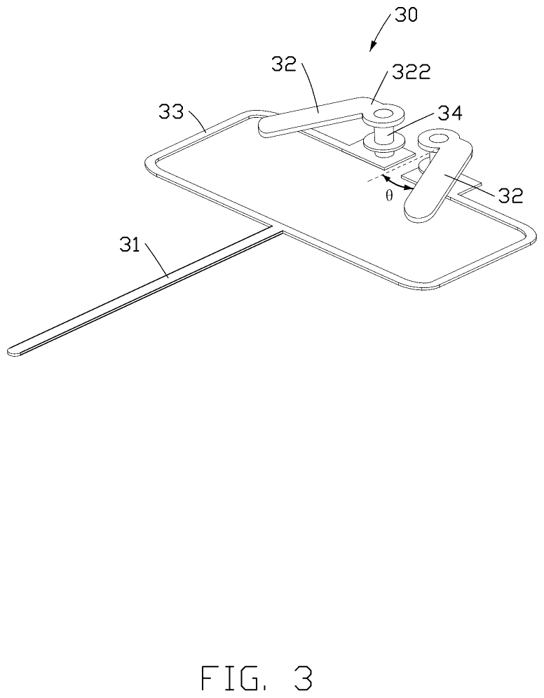

Referring to FIGS. 2 and 3, the direction from the connection point 322 of the second end 32 toward the first end 31 has an angle θ with a direction perpendicular to a side of the second connecting portion 34. In some embodiments, the angle θ may range from, but is not limited to, 0 degrees to 90 degrees.

In some embodiments, a signal conduction direction of the at least the two second ends 32 is substantially opposite to a signal conduction direction of the first end 31. In some embodiments, a vector difference between the signal conduction direction of the first end 31 and the signal conduction direction of the at least two second ends 32 may be 90 degrees to 180 degrees. For instance, the signal conduction direction of the first end 31 is toward the first connecting portion 33, the signal conduction direction of the first end 31 can be defined as a first vector. The first connecting portion 33 obtains a signal from the first end 31 and transmits the signal to the two second connecting portions 34. The at least two second ends 32 are respectively connected to the two second connecting portions 34 through the connection points 322 and serve as endpoints of the signal conduction of the at least two second ends 32, the structure along the at least two second ends 32 serves as a path for the signal conduction of the at least two second ends 32, the signal conduction direction of the at least two second ends 32 may be defined as a second vector, and the vector difference between the first vector and the second vector may be 90 degrees to 180 degrees. It can be understood that when the at least two second ends 32 are signal input ends, the first end 31 is a signal output end, and the signal conduction paths can be the same as described above, but the signal conduction directions are opposite, which will not be repeated here.

In some embodiments, each of the first end 31 and the at least two second ends 32 have a first resistance value, and the first connecting portion 33 has a second resistance value, wherein the first resistance value may be less than or equal to the second resistance value. The first resistance value may be, but is not limited to, 50 ohms (Ω), and the second resistance value may be, but is not limited to, 70.7 ohms. In some embodiments, a signal conduction path of the first end 31 is divided into two signal conduction paths of the at least two second ends 32, in order to make the energy equal, the first connecting portion 33 connecting the first end 31 and the at least two second ends 32 meets a formula Z=\sqrt{2} *Z₀, wherein Z₀ is the first resistance value of the first end 31 and the at least two second ends 32, that is Z₀=50 ohms, Z is the second resistance value of the first connecting portion 33, calculation shows that Z=70.7 ohms. Since the first end 31 and the at least two second ends 32 are respectively set with the same preset resistance value, and the first connecting portion 33 is set with a different preset resistance value, the energy conducted by the first end 31, the first connecting portion 33, and the at least two second ends 32 is substantially equal, thereby reducing the loss of energy conduction. In some embodiments, to match the configuration of the array antenna module 1, the first connecting portion 33, the first end 31 and the at least two second ends 32 may have different line widths, so that the first connecting portion 33 and the first end 31, at least two second ends 32 may have substantially equal signal conduction powers.

The first end 31 may be used to receive a wireless communication signal from the array antenna 10 through the LNA 20. The first end 31, the first connecting portion 33, the second connecting portions 34, and the at least two second ends 32 sequentially conduct the wireless communication signal, and then the at least two second ends 32 conduct the wireless communication signal to the beamforming module 40. Alternatively, the first end 31 can receive a wireless communication signal from the beamforming module 40, and the first end 31, the first connecting portion 33, the second connecting portions 34, and the at least two second ends 32 sequentially conduct the wireless communication signal, and then the at least two second ends 32 conduct the wireless communication signal to the array antenna 10 through the LNA 20.

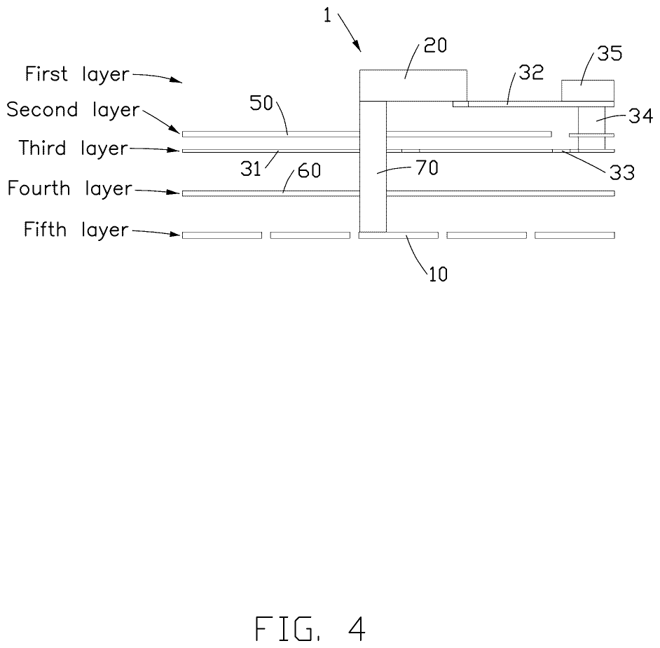

Referring to FIG. 4, in some embodiments, the array antenna module 1 may be a multi-layer structure. The first end 31 is connected to the first connecting portion 33, and the first end 31 is coplanar with the first connecting portion 33, the first end 31 and the first connecting portion 33 may be located on a same layer of the array antenna module 1, such as a third layer. The at least two second ends 32 may be located at another layer of the array antenna module 1, such as a first layer. The second connecting portions 34 run through the layer where the first end 31 and the first connecting portion 33 are located and the layer where the at least two second ends 32 are located, that is, the second connecting portions 34 run through the first layer to the third layer. In some embodiments, at least two first through holes are formed through the first layer and the third layer of the array antenna module 1, and the at least two first through holes are filled with metal conductors to form the second connecting portions 34. An extension direction of the at least two second ends 32 is substantially the same as that of the first end 31, and the at least two second ends 32 extend to be spaced apart from the first connecting portion 33.

The multiplexer 30 may further include a resistor 35. The resistor 35 contacts the at least two second ends 32. In some embodiments, the resistor 35 contacts one end of the at least two second ends 32 connected to the second connecting portions 34, and the resistor 35 is disposed on the first layer of the array antenna module 1.

In some embodiments, the array antenna 10 can be arranged on another layer of the array antenna module 1, which is not coplanar with the layer where the first end 31 and the first connecting portion 33 are located and the layer where the at least two second ends 32 are located, for example, the array antenna 10 can be arranged on a fifth layer of the array antenna module 1. In some embodiments, the fifth layer where the array antenna 10 is located may be a surface layer of the array antenna module 1, and the first layer where at least two second ends 32 are located may be an internal layer of the array antenna module 1. In some other embodiments, the first layer where the at least two second ends 32 are located may be a surface layer of the array antenna module 1, and the fifth layer where the array antenna 10 is located may be an internal layer of the array antenna module 1. The LNA 20 may be disposed on the first layer of the array antenna module 1.

In some embodiments, the array antenna module 1 may further include a first ground layer 50 and a second ground layer 60.

The first ground layer 50 may be located between the layer where the first end 31 is located and the layer where the at least two second ends 32 are located, for example, a second layer of the array antenna module 1. The second ground layer 60 may be located between the layer where the first end 31 is located and the layer where the array antenna 10 is located, such as a fourth layer of the array antenna module 1. The first ground layer 50 and the second ground layer 60 may be used to provide grounding for the array antenna 10 and the multiplexer 30.

In some embodiments, a second through hole is formed from the first layer through the fifth layer of the array antenna module 1, the second through hole is filled with a metal conductor to form a third connecting portion 70. The third connecting portion 70 penetrates the first layer to the fifth layer of the array antenna module 1 to respectively connect the LNA 20 on the first layer and the array antenna 10 on the fifth layer, so as to achieve electrical connection and signal conduction between the LNA 20 and the array antenna 10. It can be understood that the multi-layer structure of the array antenna module 1, for example, the first layer to the fifth layer can be spaced apart from each other and arranged in parallel.

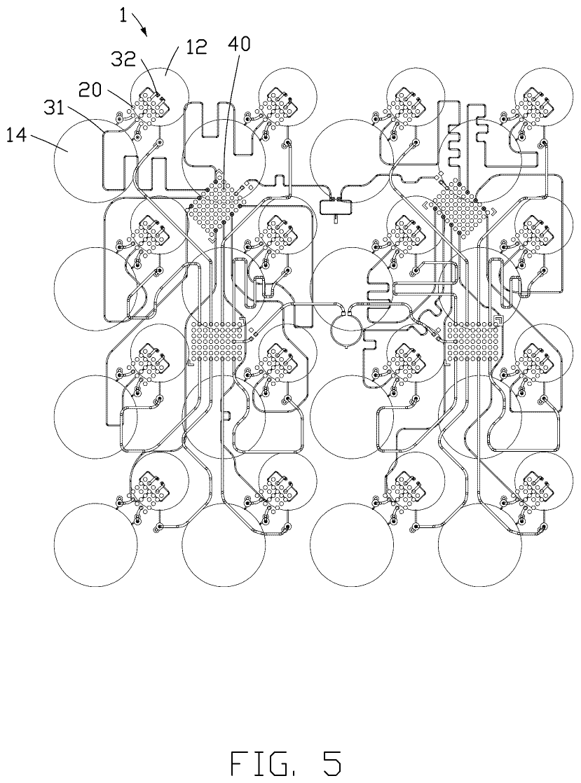

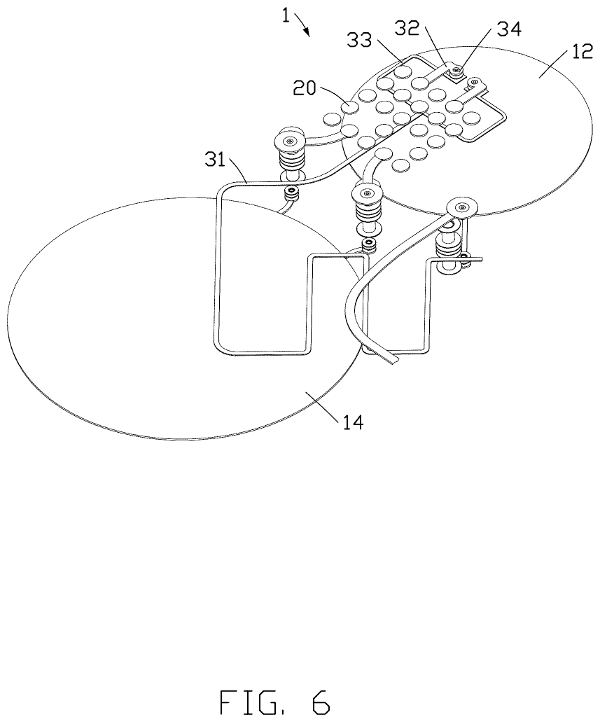

Referring to FIGS. 5 and 6, the array antenna 10 may include a plurality of transmitting antennas 12 and a plurality of receiving antennas 14.

The plurality of transmitting antennas 12 are arranged in rows. In each row, every two adjacent transmitting antennas 12 are spaced apart by a first predetermined distance.

The plurality of receiving antennas 14 are arranged in rows. In each row, every two adjacent receiving antennas 14 are spaced apart by a second predetermined distance. Each receiving antenna 14 is staggered between two transmitting antennas 12.

Each row of transmitting antennas 12 and each row of receiving antennas 14 are staggered to form an array arrangement, that is, to form the array antenna 10. In some embodiments, the first predetermined distance may be greater than, equal to, or less than the second predetermined distance, and this application does not limit this.

The multiplexer 30 is staggered between the transmitting antenna 12 and the receiving antenna 14. In some embodiments, the array antenna module 1 may include a plurality of multiplexers 30, and each multiplexer 30 may be connected to a group of transmitting antennas 12 and receiving antennas 14. Wherein, the plurality can include “one” or “plurality”.

When the at least two second ends 32 of the multiplexer 30 are connected to the receiving antennas 14 of the array antenna 10 through the LNA 20, the first end 31 is connected to the beamforming module 40, and the multiplexer 30 can be used as a power combiner to receive the wireless communication signal of the array antenna 10 through the at least two second ends 32 and conduct the wireless communication signal to the beamforming module 40 through the first end 31. Alternatively, when the at least two second ends 32 of the multiplexer 30 are connected to the transmitting antennas 12 of the array antenna 10 through the LNA 20, the first end 31 is connected to the beamforming module 40, and the multiplexer 30 can be used as a power divider to receive the wireless communication signal of the beamforming module 40 through the first end 31 and conduct the wireless communication signal to the array antenna 10 through the at least two second ends 32.

In some embodiments, the beamforming module 40 may be connected to the first end 31 of one or more multiplexers 30. For example, the beamforming module 40 may be connected to the first end 31 of eight multiplexers 30, the at least two second ends 32 of each multiplexer 30 can be connected to one of a group of transmitting antennas 12 and receiving antennas 14 of the array antenna 10, so one beamforming module 40 can be connected to eight groups of transmitting antennas 12 and receiving antennas 14 through eight multiplexers 30. Among the multiple multiplexers 30 connected to the beamforming module 40, a length of the connection between the first end 31 of each multiplexer 30 and the beamforming module 40 is approximately equal, so that the signal conduction paths between the beamforming module 40 and the multiple multiplexers 30 are approximately the same length, which can have approximately equal energy conduction losses, thereby ensuring that the signal conduction quality of each signal conduction path is approximately the same, and is also more conducive to the signal conduction wiring of the multiple multiplexers 30 in the entire array antenna module 1. In other embodiments, one beamforming module 40 may also be connected to two, four, or sixteen groups of transmitting antennas 12 and receiving antennas 14, which is not limited in the present application.

The multiplexer 30 provided in the present application is connected to the array antenna 10 through one of the first end 31 or the at least two second ends 32, and the other of the first end 31 or the at least two second ends 32 is connected to the beamforming module 40, so that the multiplexer 30 can conduct signals between the array antenna 10 and the beamforming module 40, the signal conduction direction of the at least the two second ends 32 is opposite to the signal conduction direction of the first end 31, so that the multiplexer 30 is not arranged flat on the same plane, saving the design space of the multiplexer 30 on the plane and being more conducive to the signal conduction wiring of the array antenna module 1.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A multiplexer applied in an array antenna module, the array antenna module comprising an array antenna and a beamforming module, the multiplexer comprising:
a first end; and
at least two second ends extending towards the first end;
wherein one of the first end or the at least two second ends is connected to the array antenna, the other one of the first end or the at least two second ends is connected to the beamforming module, the first end and the at least two second ends are configured to conduct signals between the array antenna and the beamforming module.

2. The multiplexer of claim 1, wherein the first end and the at least two second ends are in different layers.

3. The multiplexer of claim 1, further comprising a first connecting portion, wherein the first connecting portion is connected to the first end and is coplanar with the first end.

4. The multiplexer of claim 1, further comprising at least two second connecting portions, wherein one end of each of the at least two second connecting portions is connected to an end of the first connecting portion away from the first end, and the other end of the at least two second connecting portions are connected to the at least two second ends, respectively, the at least two second connecting portions connect the layer where the first end is located and the layer where the at least two second ends are located.

5. The multiplexer of claim 1, further comprising a resistor, wherein the resistor contacts the at least two second ends.

6. The multiplexer of claim 5, wherein the resistor and the at least two second ends are in a same layer.

7. The multiplexer of claim 1, wherein when the at least two second ends are connected to receiving antennas of the array antenna, the first end is connected to the beamforming module, the multiplexer serves as a power combiner to receive the signal of the array antenna through the at least two second ends and conduct the signal to the beamforming module through the first end.

8. The multiplexer of claim 1, wherein when the at least two second ends are connected to transmitting antennas of the array antenna, the first end is connected to the beamforming module, the multiplexer serves as a power divider to receive the signal of the beamforming module through the first end and conduct the signal to the array antenna through the at least two second ends.

9. An array antenna module comprising:
an array antenna;
a beamforming module; and
a multiplexer comprising:
a first end; and
at least two second ends extending towards the first end;
wherein one of the first end or the at least two second ends is connected to the array antenna, the other one of the first end or the at least two second ends is connected to the beamforming module, the first end and the at least two second ends are configured to conduct signals between the array antenna and the beamforming module.

10. The array antenna module of claim 9, wherein the first end and the at least two second ends are in different layers.

11. The array antenna module of claim 9, wherein the multiplexer further comprises a first connecting portion, the first connecting portion is connected to the first end and is coplanar with the first end.

12. The array antenna module of claim 9, wherein the multiplexer further comprises at least two second connecting portions, one end of each of the at least two second connecting portions is connected to an end of the first connecting portion away from the first end, and the other end of the at least two second connecting portions are connected to the at least two second ends, respectively, the at least two second connecting portions connect the layer where the first end is located and the layer where the at least two second ends are located.

13. The array antenna module of claim 9, wherein the multiplexer further comprises a resistor, the resistor contacts the at least two second ends.

14. The array antenna module of claim 13, wherein the resistor and the at least two second ends are in a same layer.

15. The array antenna module of claim 9, wherein when the at least two second ends are connected to receiving antennas of the array antenna, the first end is connected to the beamforming module, the multiplexer serves as a power combiner to receive the signal of the array antenna through the at least two second ends and conduct the signal to the beamforming module through the first end.

16. The array antenna module of claim 9, wherein when the at least two second ends are connected to transmitting antennas of the array antenna, the first end is connected to the beamforming module, the multiplexer serves as a power divider to receive the signal of the beamforming module through the first end and conduct the signal to the array antenna through the at least two second ends.

17. The array antenna module of claim 9, further comprising a low noise amplifier (LNA), wherein one end of the LNA is connected to the array antenna, the other end of the LNA is connected to the at least two second ends.

18. The array antenna module of claim 9, wherein the array antenna comprises:
a plurality of transmitting antennas arranged in rows, in each row, every two adjacent transmitting antennas are spaced apart by a first predetermined distance; and
a plurality of receiving antennas arranged in rows, in each row, every two adjacent receiving antennas are spaced apart by a second predetermined distance;
each row of transmitting antennas and each row of receiving antennas are staggered to form an array arrangement;
the multiplexer is staggered between the transmitting antenna and the receiving antenna.

19. The array antenna module of claim 10, further comprising a first ground layer, wherein the first ground layer is located between the layer where the first end is located and the layer where the at least two second ends are located.

20. The array antenna module of claim 19, further comprising a second ground layer, wherein the second ground layer is located between the layer where the first end is located and the layer where the array antenna is located.
